(19) United States
(12) Patent Application Publication
(10) Pub. No.: US 2025/0326276 A1
(43) Pub. Date: Oct. 23, 2025

(54) HVAC SYSTEM FOR REMOVAL OF MOISTURE OF AIR FLOWING THERETHROUGH

(71) Applicant: MAHLE INTERNATIONAL GMBH, Stuttgart (DE)

(72) Inventors: Edward WOLFE, Clarence Center, NY (US); Bailey REID, Lockport, NY (US); Austin MACEY, West Seneca, NY (US); Debashis GHOSH, Amherst, NY (US)

(21) Appl. No.: 19/034,429

(22) Filed: Jan. 22, 2025

Related U.S. Application Data
(60) Provisional application No. 63/635,070, filed on Apr. 17, 2024.

(51) Int. Cl. B60H 3/02; B01D 53/26

(52) U.S. Cl. CPC B60H 3/024; B01D 53/265; B01D 53/268; B01D 2257/80; B01D 2258/06; B01D 2259/4566

(57) ABSTRACT

A heating and ventilation system is provided. The system includes a housing with air inlet that receives air from a fan, which takes an intake from either or both of fresh air from outside of the vehicle and the passenger compartment. The housing includes a semipermeable membrane that is aligned to receive air flowing from the fan. A first port receives water vapor that is removed from the air that flows into the semipermeable membrane. The housing receives an evaporator of a heat pump system.

### CROSS-REFERENCE TO RELATED APPLICATIONS

This application claims priority from U.S. Provisional Application No. 63/635,070, filed on Apr. 17, 2024, the entirety of which is hereby incorporated by reference herein.

### BACKGROUND OF THE INVENTION

This application relates to HVAC systems for vehicles or other machines that have passenger or other compartments that are desired to be environmentally controlled.

### BRIEF SUMMARY

A first representative embodiment of the disclosure is provided. The embodiment includes an heating and ventilation system. The system includes a housing comprising an air inlet and an air outlet, the air inlet comprising a first inlet that is aligned to receive air flowing from a passenger compartment of a vehicle that includes the housing. The housing comprises a semipermeable membrane that is aligned with the first inlet such that air that flows through the first inlet flows through the semipermeable membrane before flowing to the outlet. A first port is fluidly connected to the housing, such that water vapor that is removed from the air that flows into the semipermeable membrane flows into the first port from the semipermeable membrane. The housing further comprising an evaporator that is disposed in a position to receive air flow that has passed through the semipermeable membrane.

Other representative embodiments of the disclosure include the structure described by the Numbered Paragraphs at the end of this specification including all of the various combinations of elements within the various Numbered Paragraphs.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a front perspective view of a housing of a HVAC system that includes a semipermeable membrane that air flows therethrough.

FIG. 2 is a rear perspective view of the housing of FIG. 1 with the evaporator removed.

FIG. 3 is a cross-sectional view of FIG. 1 along section A-A that depicts air flow through the semipermeable membrane, with the evaporator removed.

FIG. 3a is the view of FIG. 3 with the evaporator installed (schematic).

FIG. 3b is a perspective view of the section view of 3a, modified to provide a connection between the first port that is connected to the semipermeable membrane and the sump that is below the evaporator.

FIG. 4 is perspective cross-sectional view of the housing of FIG. 1 depicting section A-A of FIG. 1 with the evaporator removed and schematically depicting air flow along flow path Z through the semipermeable membrane.

### DETAILED DESCRIPTION OF THE INVENTION

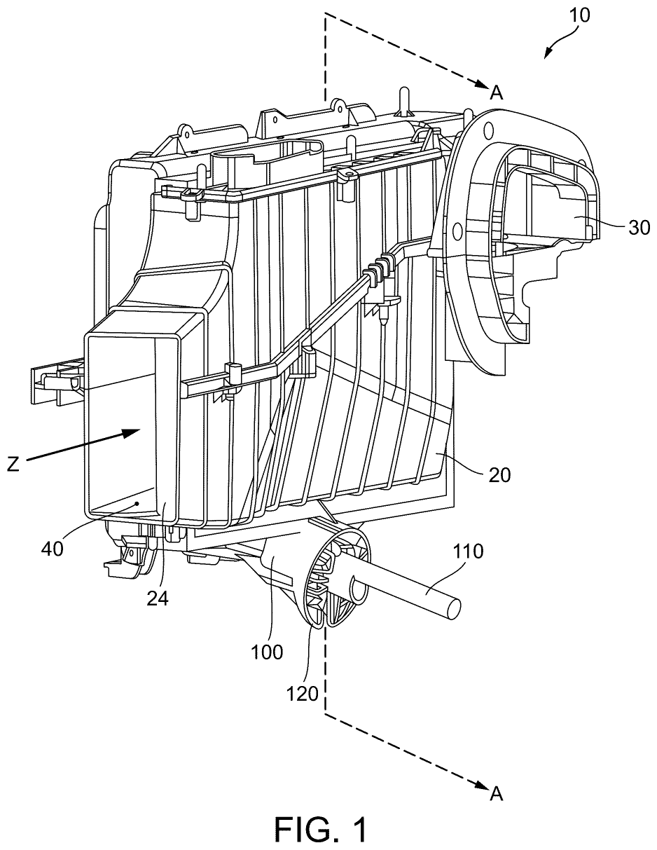

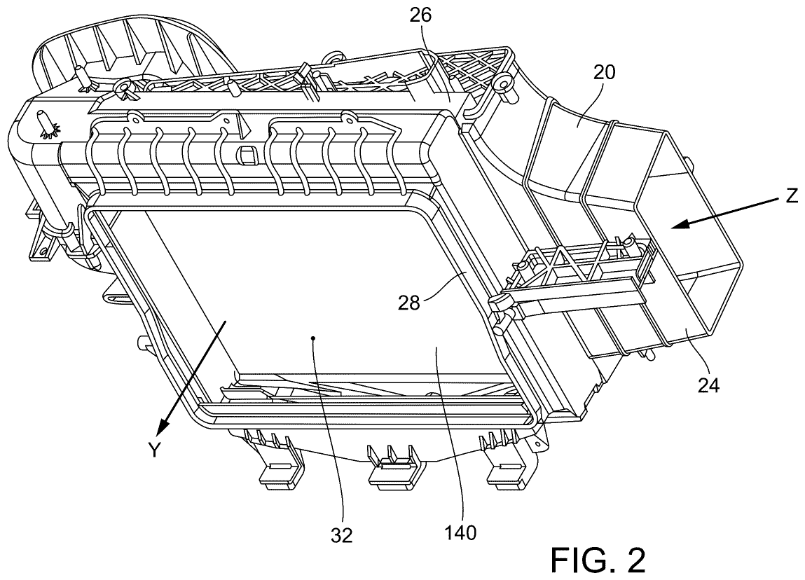

Turning now to FIGS. 1-4, a heating and ventilation system 10 is provided. The heating and ventilation system 10 is provided for a heating, ventilation, and air conditioning (HVAC) system that is particularly suited for a vehicle, and in some embodiments particularly suited for a vehicle that is solely powered by electricity (typically stored within one or more batteries within the vehicle), and in other embodiments a hybrid vehicle that includes an internal combustion engine and a battery and can desired by either the internal combustion engine or the battery as desired or as appropriate. The system 10 may also be used for various types of vehicles such as passenger vehicles as well as other types of machines and heavy equipment that include a space (such as a passenger or operator space, or storage space) that is desired to have capability of heating or air conditioning of the space such as tractors, combines, excavators, cranes, trains, aircraft, boats, and the like. While the system 10 can be successfully implemented for all of these types of vehicles and machines (and others that have one or more conditioned spaces) this specification will refer to the use of the system 10 within a passenger vehicle for the sake of brevity.

The system 10 includes a housing 20 and is configured to selectively or continuously receive air from the fan of the HVAC assembly. The fan (not shown) receives air selectively either from a source of air from outside of the vehicle (i.e. fresh air) or receives air from within the passenger compartment of the vehicle—i.e. recirculating air, or in some circumstances receives a mixture of fresh air and recirculating air. The fan (not shown) directs air from its discharge to an intake 24 in the housing 20 as schematically shown as air input Z in the figures. Within the components upstream of the housing 20 are not shown herein but may be conventional components that are provided within vehicles that include HVAC systems to allow for conditioning of air within a passenger compartment of a vehicle (or in some embodiments a non-passenger compartment of a vehicle that is otherwise desired to be temperature and/or humidity controlled).

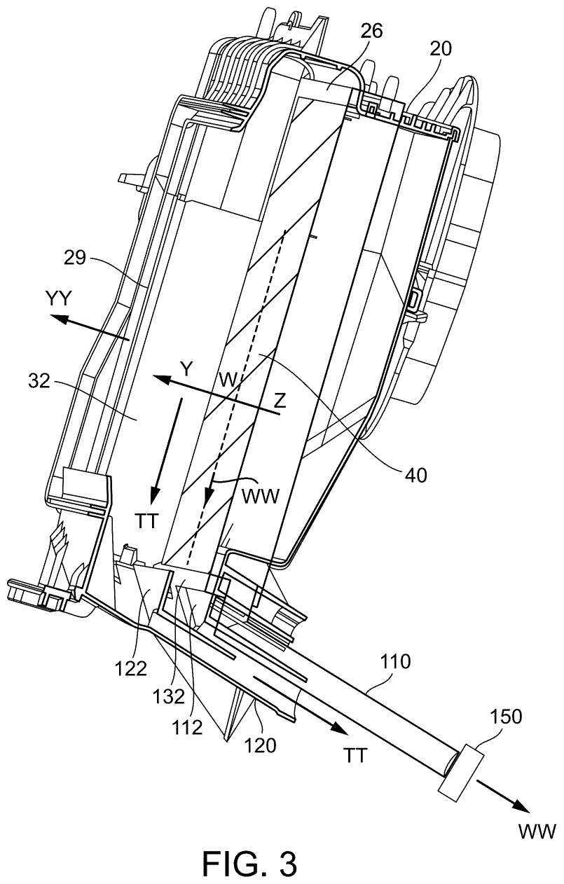

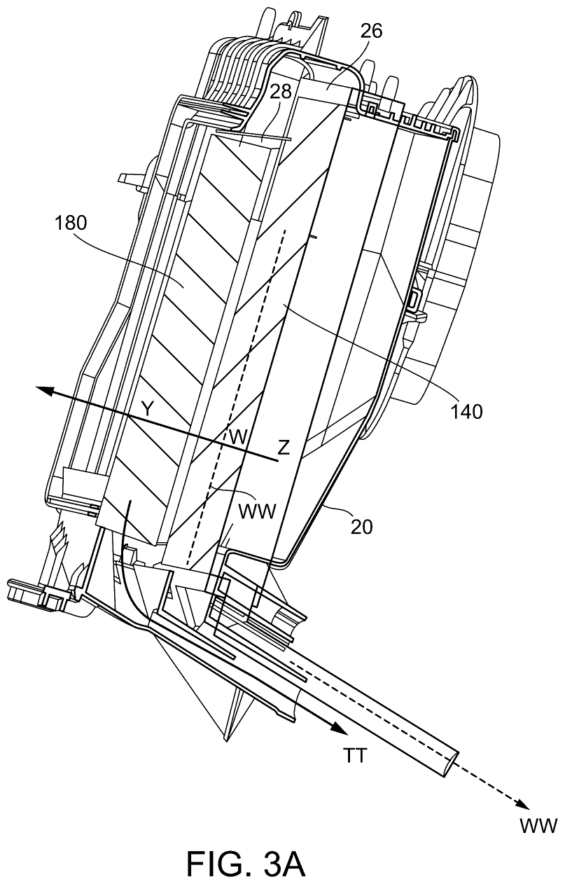

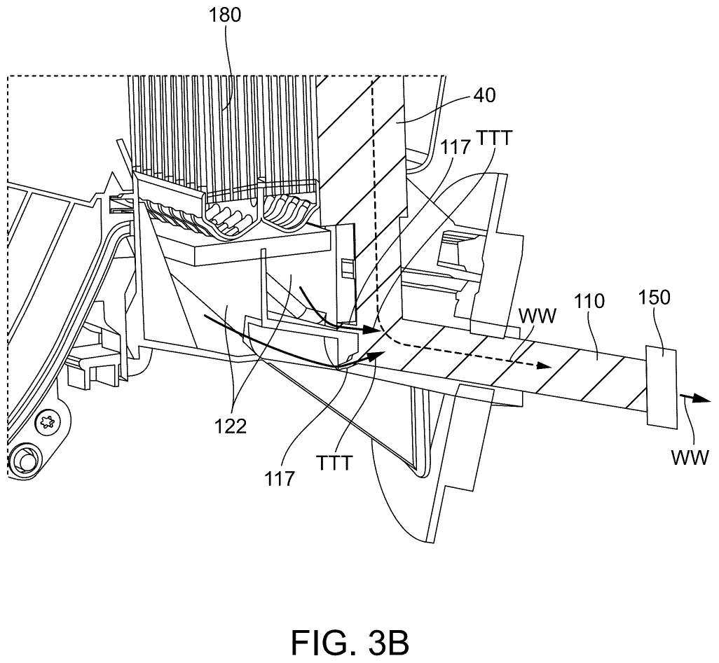

The housing 20 includes a semipermeable membrane 140 and an evaporator 180 (FIG. 3a) that is provided such that air flows through both of the semipermeable membrane 140 and the evaporator 180 as air flows through the housing, as discussed below. The evaporator 180 may be a part of a larger heat pump system within the vehicle (not shown) with the evaporator, during heat pump operation tending to cool the air that flows therethrough to allow air that flows out of the evaporator 180 and the housing 20 to be at a lower than the air that flowed into the housing via path X as discussed below. The operation of a heat pump and an evaporator within a heat pump system is well known in the art.

The evaporator 180 during some modes of operation causes some moisture content within the air that flows across and through the evaporator to condense into liquid, which flows downwardly due to gravity as depicted schematically as TT in FIGS. 3 and 3a. The housing includes a first collection area, for a second sump 122 that receives liquid that flows downwardly along the evaporator 180, and leads to a second port, or second drain 120 that allows liquid in the collection area (or in some embodiments directly from the evaporator 180) to flow out of the housing 20, as depicted schematically in the figures. The second port 120 is positioned vertically below the evaporator 180 when the housing is installed within a vehicle, such that condensed liquid/water vapor flows from the evaporator and into the second port 120 due to the force of gravity. Below is defined herein to be at a lower vertical position with respect to the force of gravity when the housing 20 is installed within a vehicle, and also vertically fully or partially aligned with the evaporator such that liquid from the evaporator flows downwardly or falls due to the force of gravity into the second port 120. In some embodiments, a second sump 122 may be disposed vertically below the evaporator (when the housing 20 is installed within a vehicle) such that liquid from the evaporator flows into the second sump 122, with liquid able to flow due to gravity from the second sump 122 and into the second port.

In some embodiments the first port 110 and the second port 120 extend in parallel with each other outside of the housing 20. In this embodiment, the first and second port (downstream of the suction device 150) may drain to the same location within the vehicle—or drain out of the vehicle at the same location.

As depicted in FIG. 3b in some embodiments, the first port 110 may include one or more connections 117 that lead to the second sump 122, such that suction from the vacuum source 150 may be provided into the second sump 122 through the connections 117, which assists with draining (or vacuum dragging) liquid from within the second sump 122 out of the HVAC system. FIG. 3B depicts the liquid from the second sump 122 flowing through the connections 117 as TTT (schematic).

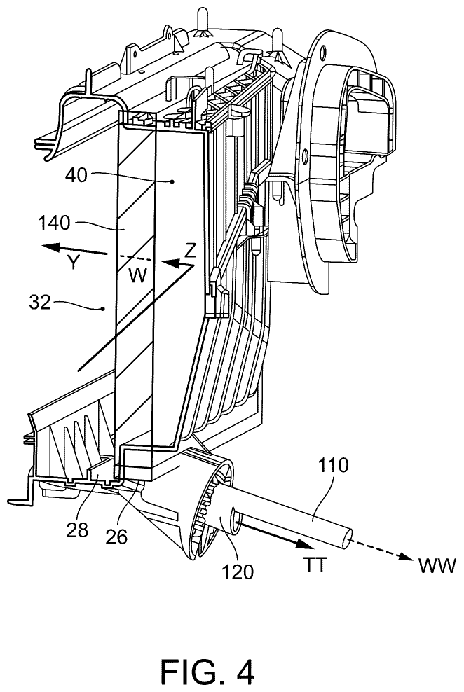

The housing 20 further supports a semipermeable membrane 140 that is disposed therewithin, with the air that flows through the first inlet 24 (schematically depicted as flow path Z) flows through the semipermeable membrane 140, as depicted in FIG. 4.

The semipermeable membrane 140 is supported within the housing 20 with a support, or a seal, 26 that fixes the semipermeable membrane 140 in place, and prevents (or substantially prevents) air Z that flows into the first plenum 40 within the housing 20 from bypassing the semipermeable membrane 140. In some embodiments, the seal 26 establishes a tortious flow path for air that flows through the first inlet 24 to through the housing 20 and bypass the semipermeable membrane 140. The seal extends around the entire perimeter of the housing along the an inner surface of the housing 20 and establishes and aperture 110a that the first port 110 extends thru to allow fluid flow from the semipermeable membrane 140 and into the first port 110. The seal 26 may extend from the first port 110. The seal 26 may be disposed between the outer perimeter of the semipermeable membrane 140 and the inner surface of the housing 20 that is configured to accept the housing. The term substantially prevents means that only a di minimus percentage of the air that flows into the first plenum flows out of the housing 20 without flowing through the semipermeable membrane 140, such as 5 percent or less of the total air that flows into the first plenum 40.

The semipermeable membrane 140 is configured to allow air that flows into the semipermeable membrane 140 to flow therethrough (as schematically depicted in FIGS. 3 and 3a with air Z flowing through within the semipermeable membrane 140 as W and leaving the semipermeable membrane 140 as arrow Y), with a substantial portion of the moisture (i.e. water vapor) that is entrained with the air blocked from flowing through the semipermeable membrane 140 and flowing through the semipermeable membrane (as depicted by the broken line WW). The moisture (water vapor) may flow downwardly through the semipermeable membrane 140 and in some embodiments into a sump 112 that is disposed below the semipermeable membrane 140 and out of the sump 112 through a first port 110. In other embodiments, the sump 112 is not provided and the first port 110 is directly connected to the semipermeable membrane 140. The first port 110 is connected to the semipermeable membrane 140 with a second seal 132 that prevents water vapor moving therethrough from leaving the semipermeable membrane other than through the first port 110.

The first port 110 may be connected to a vacuum source 150 (negative pressure source) that during operation draws a vacuum/suction within the first port 110 that is communicated to the semipermeable membrane 140 (and the sump 112 when provided), which directs the suction to the semipermeable membrane to “pull” the water (flow WW, FIGS. 3, 3a) within the semipermeable membrane 140 that is prevented or restricted from passing therethrough with the air out of the membrane and to the first port 110. Operation of the vacuum source 150 urges water vapor within the semipermeable membrane to flow through the first port 110 and out of the housing 20.

Due to the presence of the semipermeable membrane 140 the air that flows through and out of the semipermeable membrane 140 (as depicted schematically as W, and Y) includes a significantly lower percentage of water vapor than the air that flows into the housing 20 via the first inlet 24 (air flow schematically as Z). The air (Y) leaving the semipermeable membrane 140 has a lower amount of water vapor than the air Z that enters the semipermeable membrane.

The presence of the semipermeable membrane 140 in the HVAC system when operated for a duration of time lowers the humidity within the passenger compartment when the air drawn into the housing by the fan and through the inlet 24 (air flow Z) is completely or partially recirc air from the passenger compartment (or depending upon the air flow rate through the HVAC system may maintain the humidity constant or may slow down the rate of increase of humidity within the passenger compartment due to the presence of passengers within the passenger compartment—which tend to increase the humidity within the passenger compartment over time). The decrease of the relative humidity (which also decreases the dew point for a given temperature) reduces the tendency of the windows within the passenger compartment to fog up with use—due to the lower temperature at the window equaling the dew point during cold weather operation of the vehicle. This lower dew point allows for air from the passenger compartment to be drawn into the HVAC system (i.e. through the first inlet 24) for desired heating of the air (by a heat pump heater and also in some circumstances an electric heater—not shown, both downstream of the evaporator 180), rather than needing to pull in fresh air into the housing—which typically has a much lower moisture content than passenger compartment air during cold weather operation of the vehicle.

In conventional HVAC systems, heated air for a passenger compartment is often provided exclusively via fresh air drawn into the fan, or with a vast majority of fresh air rather than with recirculating passenger compartment air. This is because, as discussed above, the passenger compartment air typically has a much higher dew point and relative humidity (due to the presence of passengers that continuously give off water vapor into the passenger compartment air) than external air during cold weather operation of the vehicle—because the external air during cold weather has a very low relative humidity. With the operation of the semipermeable membrane 140 the relative humidity of the air returning to the passenger compartment from the HVAC has a much lower dew point and therefore the windows of the passenger compartment do not fog up at all or as much.

The usage of passenger compartment air by the HVAC system (as opposed to outside air) is beneficial particularly for electric vehicles or hybrid vehicles that are being currently operated by the battery. In electric vehicles or hybrid vehicles currently being powered by the battery, the operation of the HVAC and particularly the heat pump system to allow the heat pump heater (and electric heater when needed) to heat up the air flowing therepast (Y) requires a significant amount of electrical power, which decreases the vehicle battery's remaining charge, and therefore decreasing the distance that the vehicle can travel before stopping to recharge the vehicle's battery—or for hybrid vehicles the distance that the vehicle can travel without returning to use of the internal combustion engine for vehicle torque and to recharge the battery. The decrease of the HVAC load on the battery due to the relatively low amount of heat input needed when the HVAC housing 20 receives passenger compartment air (which at steady state operation is substantially warmer than the outside air when the vehicle is running in a cold weather environment) causes the electrical power usage of the HVAC system (heat pump system) to be minimized to maintain the passenger compartment at the desired temperature by the passengers. In comparison, when the air used by the HVAC system is fresh air, the temperature of the fresh air during cold weather operation is much lower than the desired passenger compartment temperature, which therefore requires the heat pump heater (and when necessary the electric heater) to be operating at a very high level to transfer sufficient heat to the air that passes through the evaporator 180 (air flow Y) to increase the air temperature from the entry temperature (at or close to the temperature of the outside air) to the desired temperature for the passenger compartment. This high level of operation of the heat pump system consumes significant electrical power, which drains the battery relatively fast—thereby reducing the range of the vehicle (or the reduces the time that the a hybrid vehicle must return to internal combustion engine operation—which also decreases the range of the vehicle).

In some embodiments, the housing 20 is configured to have a useful life that is the same as the semipermeable membrane 140 such that the housing and semipermeable membrane are manufactured as a single component. In other embodiments, the semipermeable membrane 140 may be such that the useful life of the semipermeable membrane 140 is less than the useful life of the housing 20 and in some embodiments the HVAC system. In these embodiments, the housing 20 is formed to be readily disassembled from the evaporator 180 and the remainder of the HVAC system, to allow for removal and replacement of the semipermeable membrane 140 and re-assembly with the evaporator 180 and the HVAC system.

The term “about” is specifically defined herein to include a range that includes the reference value and plus or minus 5% of the reference value. The term “substantially the same” is when the item under comparison is within 5% of the aspect of the reference value of the item.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The scope of the specification is readily understood with reference to the following Numbered Paragraphs:

Numbered Paragraph 1: A heating and ventilation system comprising:
a housing comprising an air inlet and an air outlet, the air inlet comprising a first inlet that is aligned to receive air flowing from a passenger compartment of a vehicle that includes the housing;
the housing comprises a semipermeable membrane that is aligned with the first inlet such that air that flows through the first inlet flows through the semipermeable membrane before flowing to the outlet;
a first port that is fluidly connected to the housing, such that water vapor that is removed from the air that flows into the semipermeable membrane flows into the first port from the semipermeable membrane; and
the housing further comprising an evaporator that is disposed in a position to receive air flow that has passed through the semipermeable membrane.

Numbered Paragraph 2: The heat and ventilation system of Numbered Paragraph 1, wherein the first port is configured to be connected to a component that during operation creates a suction within the first port, to urge water vapor within the semipermeable membrane to flow out of the housing through the first port.

Numbered Paragraph 3: The heating and ventilation system of Numbered Paragraph 2, wherein during operation of the component the suction within the first port urges water vapor within the semipermeable membrane to flow out of the housing through the first port.

Numbered Paragraph 4: The heating and ventilation system of any one of Numbered Paragraphs 1-3, further comprising a second port that is fluidly connected to the housing, the second port is positioned such that liquid flows from the evaporator into the second port.

Numbered Paragraph 5: The heating and ventilation system of any one of Numbered Paragraphs 1-4, wherein the semipermeable membrane is positioned such that air that flows through the semipermeable membrane flows directly to the evaporator.

Numbered Paragraph 6: The heating and ventilation system of Numbered Paragraph 5, further comprising a seal that establishes a connection between the first port and the semipermeable membrane.

Numbered Paragraph 7: The heating and ventilation system of Numbered Paragraph 6, wherein the seal includes an aperture that the first port extends through.

Numbered Paragraph 8: The heating and ventilation system of Numbered Paragraph 6, wherein the seal extends from the first port.

Numbered Paragraph 9: The heating and ventilation system of any one of Numbered Paragraphs 4-8, wherein the second port is positioned vertically below the evaporator when the heating and ventilation system is installed within a vehicle.

Numbered Paragraph 10: The heating and ventilation system of Numbered Paragraph 9, wherein the second port extends from a sump within the housing that is below the evaporator.

Numbered Paragraph 11: The heating and ventilation system of Numbered Paragraph 10, wherein the first and second ports are have a portion that extend in parallel outside of the housing.

Numbered Paragraph 12: The heating and ventilation system of any one of Numbered Paragraphs 4-11, wherein liquid that flows into the second port includes condensed water vapor from air that interacts with the evaporator.

Numbered Paragraph 13: The heating and ventilation system of any one of Numbered Paragraphs 4-12, wherein the first port is fluidly connected to the second port with one or more connectors, such that liquid within the second port flows through the one or more connectors to the first port.

Numbered Paragraph 14: The heating and ventilation system of Numbered Paragraph 13, wherein the first port is configured to be connected to a component that during operation creates a suction within the first port, to urge water vapor within the semipermeable membrane to flow out of the housing through the first port, wherein the suction urges liquid from within the second port to flow into the first port.

1. A heating and ventilation system comprising:
a housing comprising an air inlet and an air outlet, the air inlet comprising a first inlet that is aligned to receive air flowing from a passenger compartment of a vehicle that includes the housing, when the housing is installed within the vehicle;
the housing comprises a semipermeable membrane that is aligned with the first inlet such that air that flows through the first inlet flows through the semipermeable membrane before flowing to the outlet;
a first port that is fluidly connected to the housing, such that water vapor that is removed from the air that flows into the semipermeable membrane flows into the first port from the semipermeable membrane; and
the housing further comprising an evaporator that is disposed in a position to receive air flow that has passed through the semipermeable membrane.

2. The heat and ventilation system of claim 1, wherein the first port is configured to be connected to a component that during operation creates a suction within the first port to urge water vapor within the semipermeable membrane to flow out of the housing through the first port.

3. The heating and ventilation system of claim 2, wherein during operation of the component the suction within the first port urges water vapor within the semipermeable membrane to flow out of the housing through the first port.

4. The heating and ventilation system of claim 1, further comprising a second port that is fluidly connected to the housing, the second port is positioned such that liquid flows from the evaporator into the second port.

5. The heating and ventilation system of claim 1, wherein the semipermeable membrane is positioned such that air that flows through the semipermeable membrane flows directly to the evaporator.

6. The heating and ventilation system of claim 5, further comprising a seal that establishes a connection between the first port and the semipermeable membrane.

7. The heating and ventilation system of claim 6, wherein the seal includes an aperture that the first port extends through.

8. The heating and ventilation system of claim 6, wherein the seal extends from the first port.

9. The heating and ventilation system of claim 4, wherein the second port is positioned vertically below the evaporator when the heating and ventilation system is installed within the vehicle.

10. The heating and ventilation system of claim 9, wherein the second port extends from a sump within the housing that is below the evaporator.

11. The heating and ventilation system of claim 10, wherein the first and second ports are have a portion that extend in parallel outside of the housing.

12. The heating and ventilation system of claim 4, wherein liquid that flows into the second port includes condensed water vapor from air that interacts with the evaporator.

13. The heating and ventilation system of claim 4, wherein the first port is fluidly connected to the second port with one or more connectors, such that liquid within the second port flows through the one or more connectors to the first port.

14. The heating and ventilation system of claim 13, wherein the first port is configured to be connected to a component that during operation creates a suction within the first port, to urge water vapor within the semipermeable membrane to flow out of the housing through the first port, wherein the suction urges liquid from within the second port to flow into the first port.
